(19) United States
(12) Patent Application Publication
(10) Pub. No.: US 2018/0235204 A1
(43) Pub. Date: Aug. 23, 2018

(54) BAIT INSERT FOR RODENT BAIT STATION

(71) Applicant: SENESTECH, INC., Flagstaff, AZ (US)

(72) Inventors: Philip BLANK, Flagstaff, AZ (US); Thomas GOTH, Flagstaff, AZ (US); Loretta MAYER, Flagstaff, AZ (US); Brandy PYZYNA, Flagstaff, AZ (US); Elissa CALLOWAY, Flagstaff, AZ (US); Cheryl DYER, Flagstaff, AZ (US)

(73) Assignee: SENESTECH, INC., Flagstaff, AZ (US)

(21) Appl. No.: 15/752,265

(22) PCT Filed: Aug. 15, 2016
(86) PCT No.: PCT/US16/47026

§ 371 Date: Feb. 13, 2018

Related U.S. Application Data
(60) Provisional application No. 62/205,583, filed on Aug. 14, 2015.

(51) Int. Cl. A01M 25/00

(52) U.S. Cl. CPC A01M 25/004

(57) ABSTRACT

A bait insert including a tank filled with a liquid bait having a discharge port, a tray top having an engagement port, and a drinking area, wherein the engagement port engages with the discharge port of the tank, and a tray base sealed to the tray top, wherein the tray base includes a plurality of troughs forming an internal flow paths for the liquid bait to flow from the tank to drinking area of the tray top. Further in one embodiment, a bait insert with a spiked tray base having a spike integral to the spiked tray base configured to pierce a foil of a sealed tank is described.

### CONTINUING APPLICATION INFORMATION

The present application claims benefit of the filing date of U.S. Provisional Application Ser. No. 62/205,583, filed on Aug. 14, 2015, and incorporated herein by reference.

### BACKGROUND

### Field of the Disclosure

The present disclosure relates generally to the field of bait stations for pests. More particularly, the disclosure relates to baits stations adapted for use with rodents.

### Description of the Related Art

The “background” description provided herein is for the purpose of generally presenting the context of the disclosure. Work of the presently named inventors, to the extent is described in this background section, as well as aspects of the description which may not otherwise qualify as prior art at the time of filing, are neither expressly or impliedly admitted as prior art against the present disclosure.

Commonly, though not universally, bait stations employ features such as walls or passageways that are unitarily formed as parts of the base of the bait station. The cover associated with such a base typically spans these structures without significantly obstructing them. Typically, the bait itself is a solid dose rodent poison made to attract the pests and to be consumed by the pests.

Municipalities and industry have long used a formerly patented RAT FORTRESS (RF) enclosure for the secure presentation of the solid dose rodent poisons, in a fashion that is accessible and comfortable for the target rodents.

### SUMMARY

According to an embodiment of the present disclosure, there is provided a bait insert. The bait insert includes a tank filled with a liquid bait having a discharge port, a tray top having an engagement port, and a drinking area, the engagement port engaging with the discharge port of the tank and the drinking area providing external access to the liquid bait, and a tray base sealed to the tray top, wherein the tray base includes a plurality of troughs forming an internal flow paths for the liquid bait to flow from the tank to drinking area of the tray top.

The plurality of troughs of the tray base includes a tank basin, which is a trough configured to collect and release the liquid bait, a drink basin, which is a trough configured to store and provides external access to the liquid bait, and a flow channel connecting the tank basin and the drink basin configured to provide a flow path for the liquid bait to and from the tank basin and to and from the drink basin. The plurality of troughs further includes a spill recapture area surrounding the tank basin, the flow channel, and the drink basin.

Further, according to an embodiment of the present disclosure, there is provided a spiked bait insert. The spiked bait insert includes a sealed tank filled with a liquid bait having a discharge port, wherein the discharge port is sealed with a foil, a tray top having an engagement port, and a drinking area, wherein the engagement port engages with the discharge port of the tank, and a spiked tray base having a spike integral to the spiked tray base, wherein the spiked tray base includes a plurality of troughs forming an internal flow paths for the liquid bait to and from the tank to drinking area of the tray top the spike is configured to pierce the foil of the sealed tank to allow the liquid bait to flow from the sealed tank to the spiked tray.

The plurality of troughs of the tray base includes a spiked tank basin, which is a trough with the spike formed integral to the spiked tank basin, a drink basin, which is a trough configured to store and provides external access to the liquid bait, and a flow channel connecting the tank basin and the drink basin configured to provide a flow path for the liquid bait to and from the tank basin and to and from the drink basin. The plurality of troughs further comprises a spill recapture area surrounding the tank basin, the flow channel, and the drink basin.

The forgoing general description of the illustrative implementations and the following detailed description thereof are merely exemplary aspects of the teachings of this disclosure, and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions, Where applicable, some or all features may not be illustrated to assist in the description of underlying features. In the drawings:

FIG. 1 is an exploded view of bait insert according to an exempla embodiment of the present disclosure.

FIG. 2 illustrates a feeder tray according to an exemplary embodiment of the present disclosure.

FIG. 3 is a perspective view of a tray base according to an exemplary embodiment of the present disclosure.

FIG. 4 is a perspective view of a tray top according to an exemplary embodiment of the present disclosure.

FIG. 5 is a cross-section view of discharge port assembled with the feeder tray according to an exemplary embodiment of the present disclosure.

FIG. 6 is a cross-section view of the drinking area and the spill recapture area according to an exemplary embodiment of the present disclosure.

FIG. 7 is a cross-section view illustrating a gap for reclaiming spill according to an exemplary embodiment of the present disclosure.

FIGS. 8A-8B illustrate assembly of a tank and the feeder tray according to an exemplary embodiment of the present disclosure.

FIGS. 9A-9C illustrate a drain back process according to an exemplary embodiment of the present disclosure.

FIG. 10 illustrates an exploded view of a spiked bait insert having a spiked tray base according to an exemplary embodiment of the present disclosure.

FIG. 11A illustrates the spiked tray base according to an exemplary embodiment of the present disclosure.

FIG. 11B illustrates the spike rupturing a foil according to an exemplary embodiment of the present disclosure.

FIG. 12 illustrates assembly of the bait insert in a rat fortress according to an exemplary embodiment of the present disclosure.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed embodiment(s). However, it will be apparent to those skilled in the art that the disclosed embodiment(s) may be practiced without those specific details. In some instances, well-known structures and components may be shown in block diagram form in order to avoid obscuring the concepts of the disclosed subject matter.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “proximate,” “minor,” and similar terms generally refer to ranges that include the identified value within a margin of 20%, 10% or preferably 5% in certain embodiments, and any values therebetween.

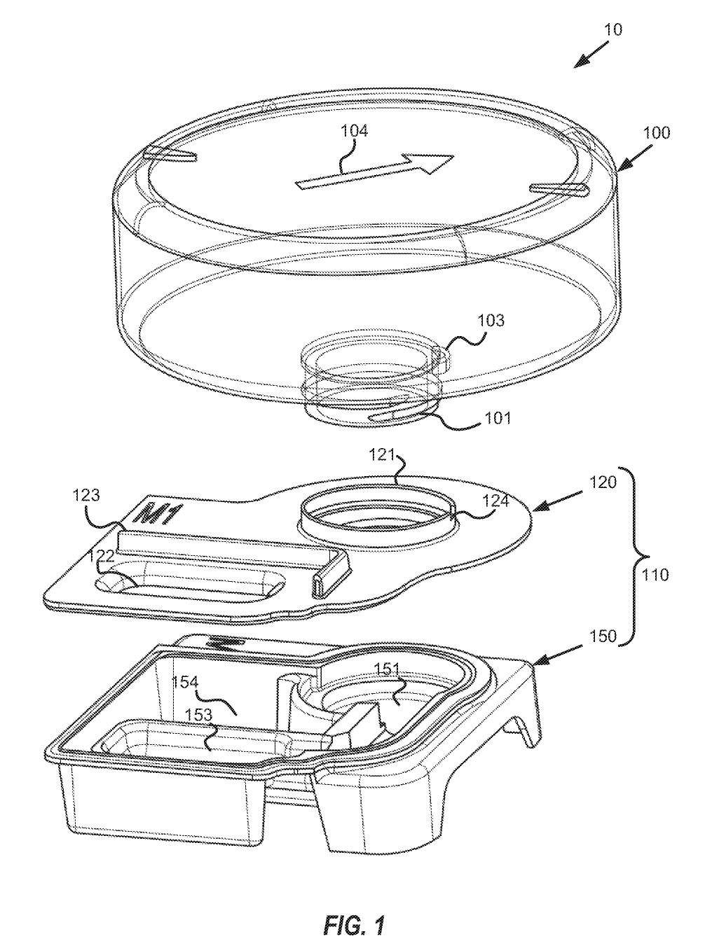

FIG. 1 is an exploded view of a bait insert 10 according to an exemplary embodiment of the present disclosure. The bait insert 10 includes a tank 100 and a feeder tray 110. The tank 100 can be a cylindrical liquid storage and/or delivery tank containing a liquid bait that affects fertility of a mammal such as rodents. The tank 100 is connected to the feeder tray 110, which allows flow of the liquid bait from the tank 100 to the feeder tray 110 for presentation and consumption by rodents.

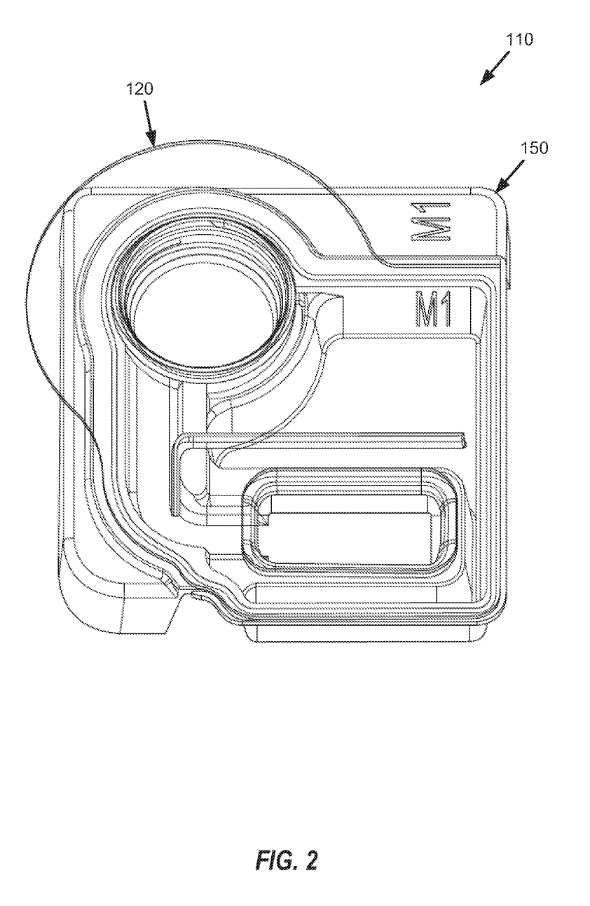

The feeder tray 110 is an assembly of a tray top 120 and a tray base 150. The tray top 120 is sealed. to the tray base 150 to prevent unwanted. leakage of the liquid bait. The feeder tray 110 is configured to create covered internal flow channels for the liquid bait to deliver the liquid bait from the tank 100 to a drinking area 122 while keeping the flow channels inaccessible. The tray top 120 can be hermetically sealed to the tray base 150 using sonic welding, adhesive or other appropriate fixing means. FIG. 2 illustrates the tray top 120 assembled with the tray base 150 to build the feeder tray 110.

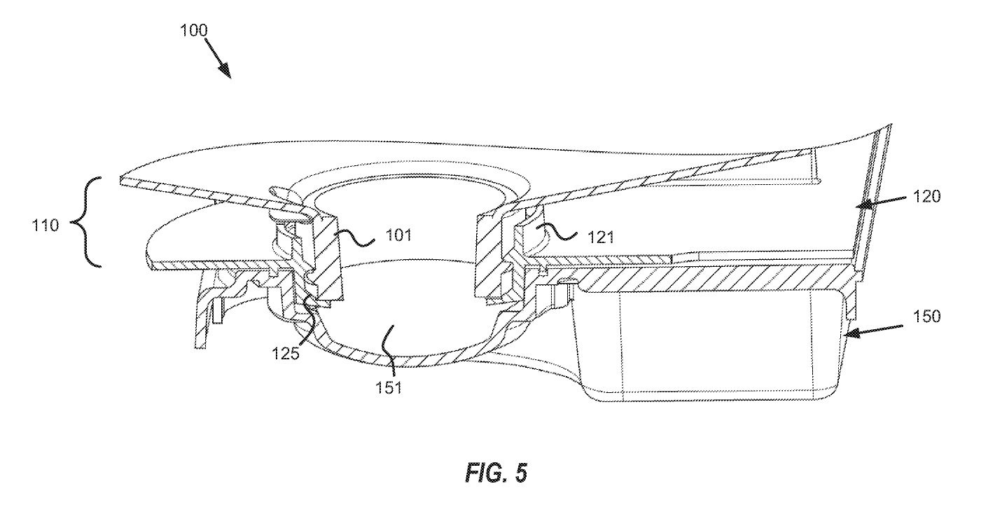

Referring back to FIG. 1, the tray top 120 provides an engagement port 121 to attach a discharge port 101 of the tank 100. When the tank 100 is in an inverted position the liquid bait in the tank 100 flows through the engagement port 121 to the feeder tray 110 for presentation and consumption by rodents. Optionally, the engagement port 121 can incorporates an positive stop 124 which can engage with a tank stop 103 of the discharge port 101 and in conjunction with a sealing flange 125 (in FIG. 5) creates a liquid-tight seal to prevent leakage of the liquid bait between the tray top 120 and the discharge port 101 of the tank 100. The tank stop 103 can also act as a stopper that allows only certain amount of rotation (e.g., two full rotations, or one and a half rotation) of the discharge port 101 into the engagement port 121.

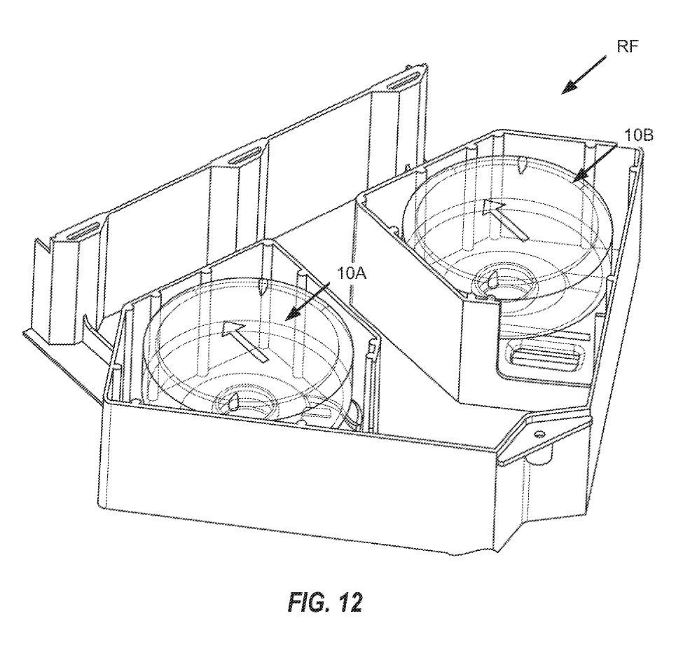

The bait insert 10 can be configured to convert a base of a RAT FORTRESSES (RF) from delivering solid dose poisons to effectively deliver a liquid bait of any type including a liquid rodent sterilant. The bait insert 10 can be configured to use a substantial percentage of the internal volume of the RF for storing the liquid bait, while also incorporating a gravity-fed self-leveling feeder tray 110 to present the liquid bait to the rodents for consumption. In one embodiment of the present disclosure, referring to FIG. 12, the bait insert 10 may be configured to include a tank designed to fit successfully in both mirror-image feeding chambers of the RF.

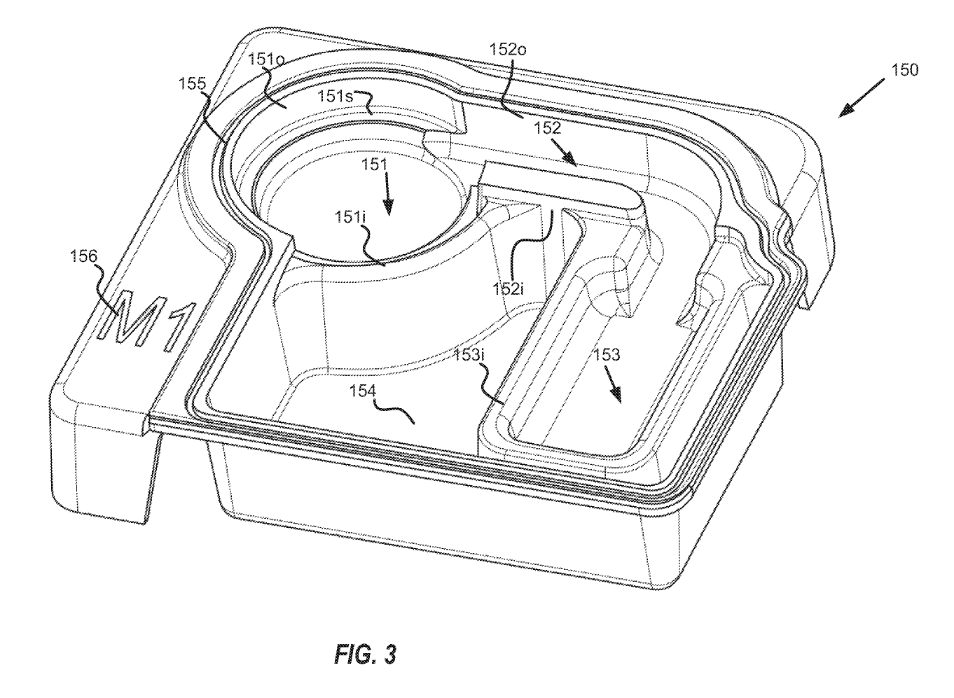

FIG. 3 is a perspective view of the tray base 150 according to an exemplary embodiment of the present disclosure. The tray base 150 provides a flow path for liquid bait that includes a of trough portions such as a tank basin 151, a flow channel 152, and a drink basin 153 connected to allow the liquid bait to flow from the tank basin 151 to the drink basin 153 in an unrestricted manner. In addition, the tray base 150 can include a spill recapture area 154 to reclaim any liquid bait that may be spilled from the tank basin 151, the flow channel 152 and/or the drink basin 153 during the use of the tray base 150, To allow the recapture of the spilled liquid bait into the spill recapture area 154, the height of inner walls of the tray base 150 are relatively smaller than the height of the outer wall. The term inner wall refers to a wall that create partitions between the troughs and are located inside the outer wall of the troughs. The outer wall is profile shaped and defines the boundary of the plurality of troughs.

The tank basin 151 is substantially circular and collects the liquid bait from the tank 100. The liquid bait from the tank basin 151 is then directed to the flow channel 152, which further directs the liquid bait to the drink basin 153. The depth of the tank basin 151 can be relatively greater than the depth of the flow channel 152 and the drink basin 153 to allow collection of the liquid bait in the tank basin 151 before the liquid bait starts flowing to the drink basin 153. The extra depth of the tank basin 151 relative to the flow channel 152 can also be advantageous to collect minor spill of the liquid bait from the tank 100 during the installation process.

The tank basin 151 can include a tank seat 151s to provide a resting surface for the discharge port 101 of the tank 100 when assembled. The tank seat 151s can also provide a support for self-leveling of the tank 100 when the feeder tray 110 may be tilted. The height of the tank seat 151s is such that the tank 100 does not obstruct the passage between the tank basin 151 and the flow channel 152, thus allowing the liquid bait to flow unobstructed.

An outer basin wall 151o of the tank basin 151 is relatively higher than the inner basin wall 151i of the tank basin 151. The inner basin wall 151i is the partition between the tank basin 151 on one side and the spill recapture area 154 on the other side. The shorter inner basin wall 151i allows the liquid bait to spill to and from the spill recapture area 154. The spill may occur during the use of the bait insert 10, due tilting or relocating, draining back, or other movements of the bait insert 10.

The flow channel 152 and the drink basin 153 can have substantially similar depths. Alternatively or in addition, the depth of the flow channel 152 and the drink basin 153 can vary. For example, the depth of the flow channel 152 can be relatively greater than the depth of the drink basin 153 to allow buffering of the liquid bait in the flow channel 152 before passing to the drink basin 153. In another example, the depth of the drink basin 153 can be relatively greater than the depth of the flow channel 152 to collect and store more quantity of the liquid bait in the drink basin 153.

The flow channel 152 has an outer channel wall 152o and an inner channel wall 152i. The inner channel wall 152i is a partition between the flow channel 152 and the spill recapture area 154. The inner channel wall 152i and the outer channel wall 152o can be substantially similar in height. This can prevent excessive spilling of the liquid bait from the flow channel 152 into the spill recapture area 154. Alternatively or in addition, the inner channel wall 152i can be smaller than the outer channel wall 152o when additional spill reclaim from the flow channel 152 is desired.

The drink basin 153 can be a rectangular trough in which the liquid bait is collected and made accessible for drinking by the rodents. The drink basin 153 is surrounded by an inner drink wall 153i that creates a partition between the spill recapture area 154 and the drink basin 153. The drink basin 153 is surrounded by the spill recapture area 154 on three sides. Alternatively or in addition, the drink basin 153 can be modified so that the spill recapture area 154 surrounds one or two sides of the inner drink wall 153. Furthermore, the inner drink wall 153i can be relatively smaller in height than the outer walls, which may include the outer basin wall 151o and the outer channel wall 152o, or the inner channel wall 152i. The drink basin 153 is not limited to a rectangular shape. Alternatively, the drink basin 153 can have a circular, oval, square, or other appropriate geometric shape.

The spill recapture area 154 is a trough surrounded by the tank basin 151, the flow channel 152 and the drink basin 153. The spill recapture area 154 can be profiled to conform to the shape of the tank basin 151, the flow channel 152 and the drink basin 153 to allow optimum utilization of the spill recapture area 154. Alternatively or in addition, the spill recapture area 154 can be of different shape such as a rectangular, a triangular, a circular, or other geometric shape. Furthermore, the spill recapture area 154 can include an array of pockets connected to each other, for example, like a beehive.

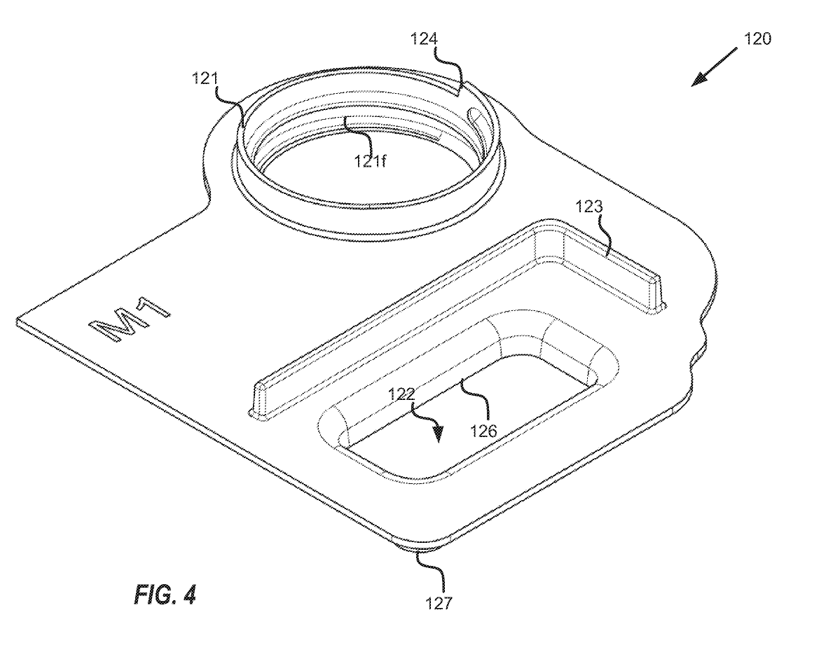

The outer walls of the drink basin 151, the flow channel 152 and the spill recapture area 154 are surrounded by a groove 155. The groove 155 allows to create a seal between the tray base 150 and the tray top 120. The groove 155 of the tray base 150 engages with a projection 127 of the tray top 120 (shown in FIG. 4). The seal can be formed by sonic-welding, adhesive, snap fitting, or other bonding materials or fitting methods.

Furthermore, the feed tray 150 can include indicia such as a first mark M1 to indicate a direction represented by an arrow, a left side or a right side represented by letters L or R, respectively, or a mark to indicate a direction or orientation for assembly purposes. For example, tray base 150 can include the first mark M1 (e.g., a letter “L”) and the tray top 120 can include a second mark M1 (e.g., a word “Left”) similar to the first mark M1. The first mark M1 of the tray base 150 can be matched with the second mark M1 of the tray top 120 to ensure correct assembly of the tray base 150 and the tray top 120.

FIG. 4 is a perspective view of the tray top 120 according to an exemplary embodiment of the present disclosure. The tray top 120 includes the engagement port 121 and the drinking area 122. The drinking area 122 is a rectangular hole that conforms to the drink basin 153 of the tray base 150. The drinking area 122 provides access for the rodents to the liquid bait from the tank 100. Thus, the rodents can drink the liquid bait from the drinking area 122. The drinking area 122 can be surrounded by a corral 123, which confines the rodents in the drinking area 122. The corral 123 can also prevent the rodents from traveling to the other side, where the rodents can hide or nap close to the tank 100. The drinking area 122 is not limited to a rectangular shape. Alternatively, the drinking area 122 can have a circular, oval, square, or other appropriate geometric shape.

The engagement port 121 is configured to fit the discharge port 101 of the tank 100.

The engagement port 121 can include an inner thread 121f. The engagement port 121 project above the tray top 121 as well as from an underside (side that contacts with the tray base 150) of the tray top 121. The underside of engagement port 121 can fit in the tank basin 151 making contact with the outer tank wall 151o and/or the inner tank wall 151i. The engagement port 121 can fit snugly with the tank basin 151 to minimize the spillage of the liquid bait into the spill recapture area 154. Furthermore, the engagement port 121 can include the positive stop 124, which limits the amount of insertion of the discharge port 101 of the tank 100 into the engagement port 121. For example, the positive stop 124 engages with the tank stop 103 when the discharge port 101 is screwed into the engagement port 121, thus preventing farther rotation of the discharge port 101 in the engagement port 121.

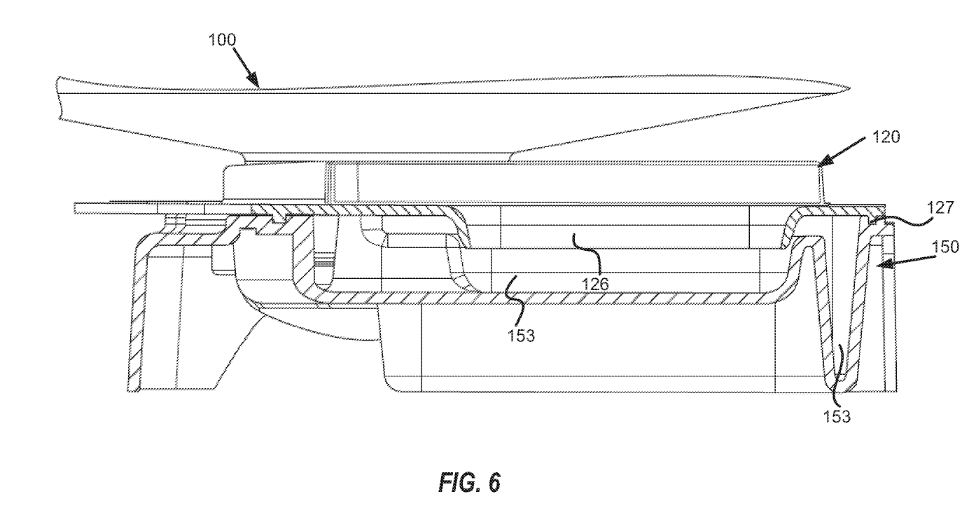

The drinking area 122 can be surrounded by an overhang 126 (also shown in FIG. 6) that project from the underside of the tray top 120. The overhand 126 rests in the drink basin 153 contacting the inner drink wall 153i. The overhang 126 can fit snugly with the inner drink wall 153i. A snug fit can be useful to minimize the spillage of the liquid bait from the drink basin 153 into the spill recapture area 154. Furthermore, the overhang 126 can prevent the rodents from entering inside the tray base 110.

The tray top 120 can also include the projection 127 (also shown in FIG. 6) on the underside of the tray top 120. The projection 127 when engaged with the groove 155 of the tray base 150 allows forming of a tight seal between the tray top 120 and the tray base 150.

The tray top 120 and the tray base 150 can be manufactured from different materials such as plastic, rubber-like material, metal (e.g., steel, aluminum, etc.), or other material that do not react with the liquid bait. The tray top 120 and the tray base 150 can be manufactured separately using techniques such as forming, stamping, casting, 3D-printing, vacuum forming, or other known manufacturing process. The tray top 120 and the tray base 150 can then be assembled and sealed together to form the feeder tray 110.

FIG. 5 is a cross-section view of the discharge port 101 assembled with the feeder tray 110 according to an exemplary embodiment of the present disclosure. The cross-section view shows the discharge port 101 of the tank 100 resting against a sealing 125 of the tray top 120. The sealing flange 125 creates a seal between the discharge port 101 and the engagement port 121 that prevents the liquid bait from leaking, even when the feed tray 110 is tilted.

FIG. 6 is a cross-section view of the drinking area 122 and the spill recapture area 154 according to an exemplary embodiment of the present disclosure. The cross-section view shows the overhang 126 of the tray top 120 resting against the inner walls of the drink basin 153 of the tray base 150. The figure also shows the spill recapture area 154 adjacent to the drink basin 153. The spill recapture area 154 can have deeper trough compared to the drink basin 153. However, the present disclosure is not limited to the depth of the trough. Alternatively or in addition, the spill recapture area 154 and the drink basin 153 can be a trough of substantially similar depths.

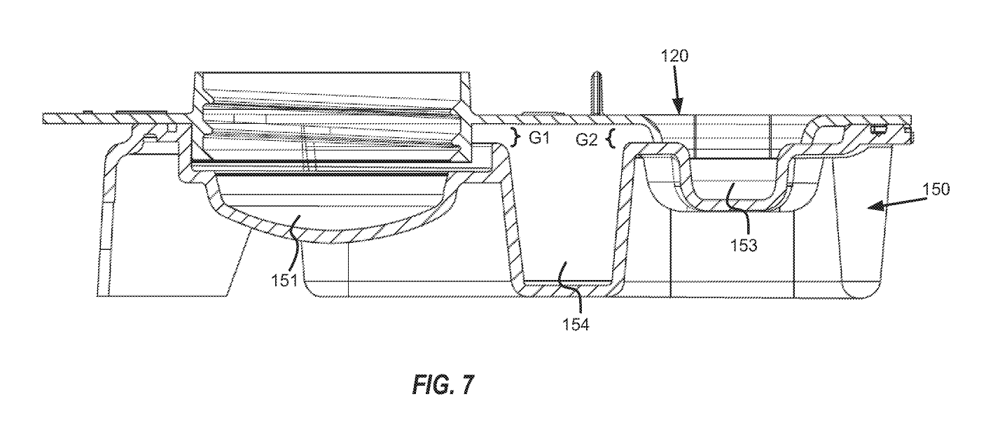

FIG. 7 is a cross-section view illustrating gaps for reclaiming spill according to an exemplary embodiment of the present disclosure. As mentioned earlier, the inner walls are smaller in height than the outer walls creating a small clearance (or gap) to allow the liquid bait to flow over the inner walls. A first gap G1 is formed between the tray top 120 and the tray base 150 around the tank basin 151 that can allow the liquid bait in the spill recapture area 154 to flow to the tank basin 151 and back into the tank 100. Similarly, a second gap G2 is created around the drink basin 153 that can allow the liquid bait in the drink basin 153 to spill and be reclaimed in the spill recapture area 154. The first gap G1 and the second gap G2 can be of similar height. Alternatively, the gaps G1 and G2 can be modified by a person skilled in art to have different heights.

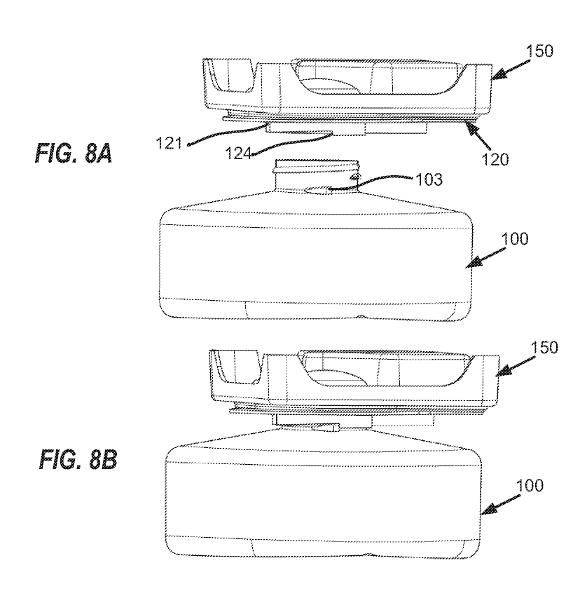

FIGS. 8A-8B illustrates a method of assembling of the tank 100 and the tray top 120 according to an exemplary embodiment of the present disclosure. According to one embodiment of the present disclosure, the tank 100 can be assembled with the tray top 120 in three steps. First, the opening of the discharge port 101 of the tank 100 is held upwards, to prevent liquid bait from flowing out due to gravity. In the second step, the engagement port 121 of the tray top 120 is attached to the discharge port 101 by rotating the tank 100 (or the feeder tray 110) till the tank stop 103 engages with the positive stop 124, Lastly, the assembly is inverted so that the liquid bait in the tank 100 flows into the feeder tray 150 under gravity.

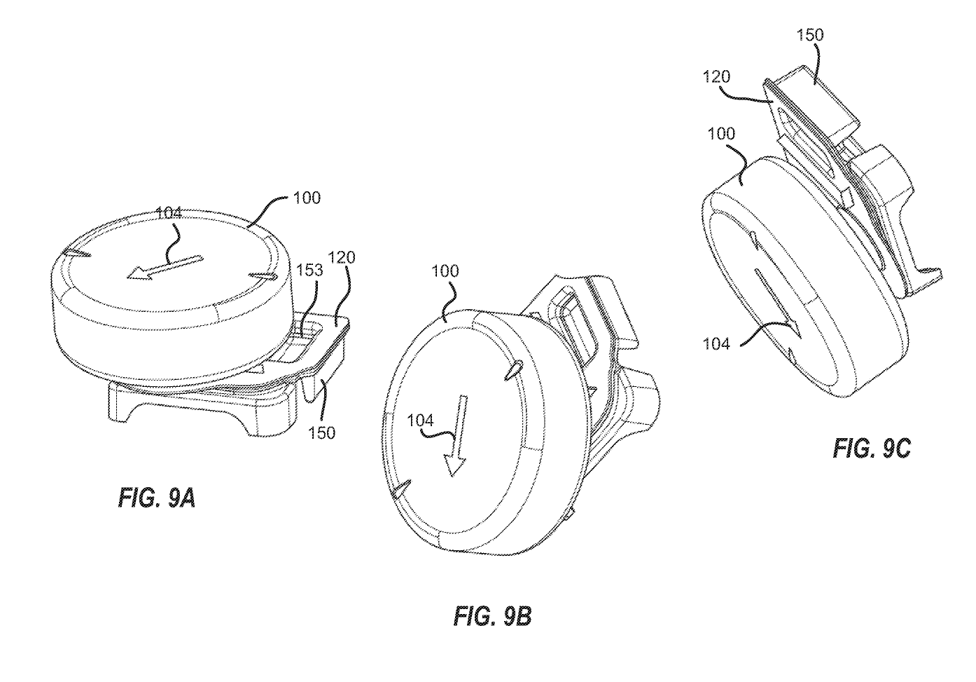

FIGS. 9A-9C illustrate a drain back process according to an exemplary embodiment of the present disclosure. The liquid bait in the drink basin 153 of the tray base 150 can be drained back into the tank 100. In order to do so, the bait insert 10 is gradually tilted in the direction indicated by the drain indicator 104. For example, FIG. 9A shows a first position, in which the bait insert is horizontal (i.e., is not tilted). FIG. 9B shows the bait insert 10 is gradually tilted from the first position to a second position, where the bait insert 10 is tilted in the direction of the drain indicator 104. The gradual tilting from the second position to the third position (in FIG. 9C) continues till all the liquid bait is drained back into the tank 100. In the drain back process the liquid bait from all the troughs including the tank basin 151, the flow channels 152, the drink basin 153 and/or the spill recapture area 151 flows back into the tank 100.

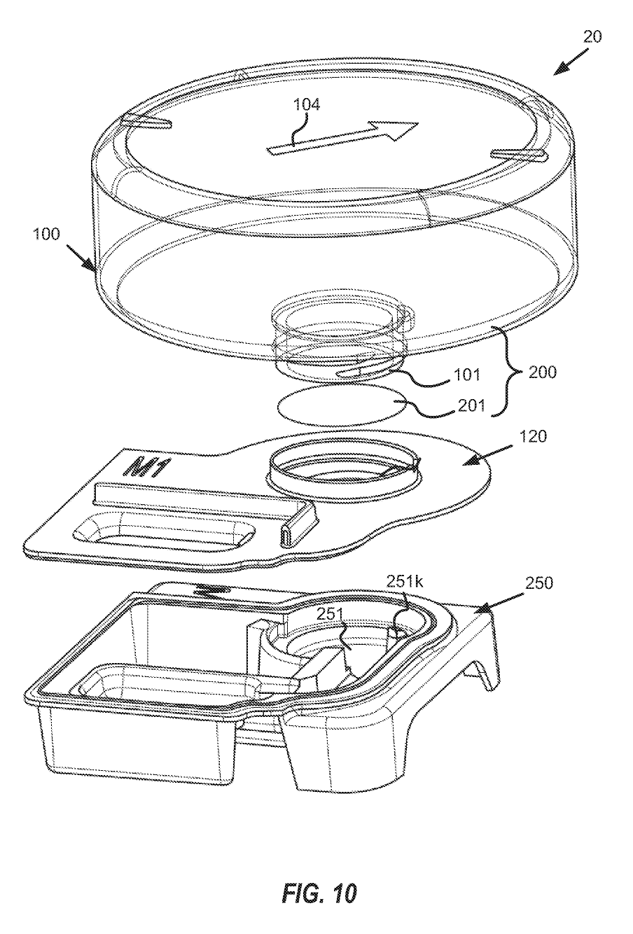

FIG. 10 illustrates an exploded view of a spiked bait insert 20 according to an exemplary embodiment of the present disclosure. The spiked bait insert 20 includes a spiked tray base 250. The spiked tray base 250 includes a spiked tank basin 251 with a spike 251k therein, The spiked tray base 250 has similar structure as the tray base 150, with addition of the spike 251k. The presence of the spike 251k allows a sealed tank 200 (i.e., tank 100 attached with a foil 201) to be installed in an inverted manner. As such, the sealed tank 200 can remain sealed until it is installed on the spiked tray base 250. In this embodiment, the sealed tank 200 can be shipped with an induction seal (e.g., the foil 201) permanently fused to the sealed tank 200. The sealed tank 200 remains hermetically sealed until the spike 251k in the spiked tank basin 251 pierces and tears the foil 201, allowing the product to flow freely.

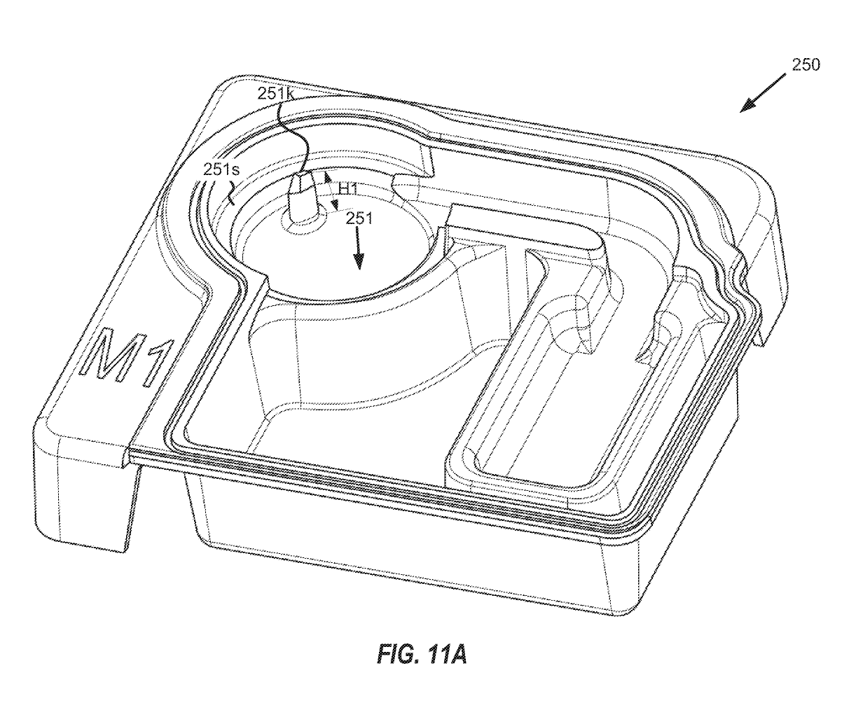

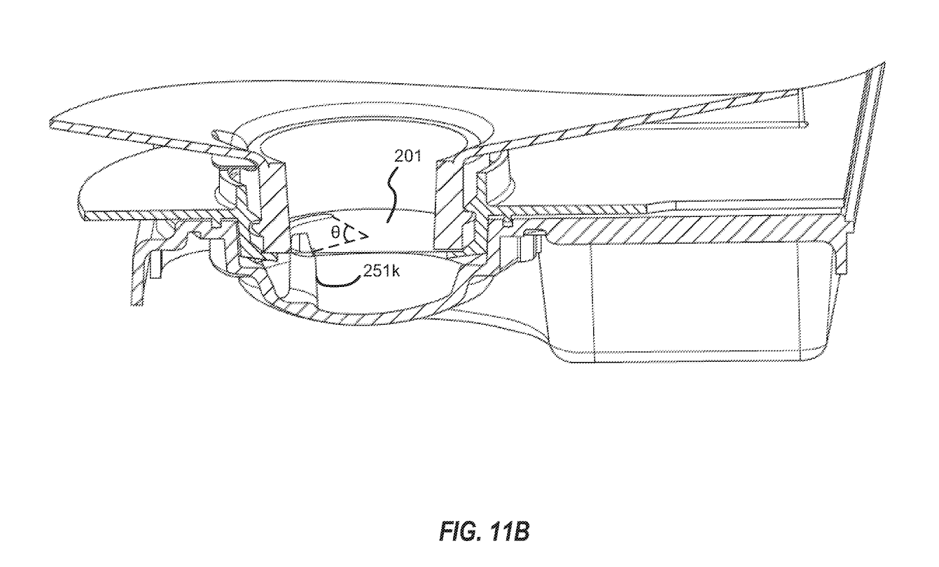

FIG. 11A illustrates a spiked tray base 250 according to an exemplary embodiment of the present disclosure. The spiked tray base 250 includes the spike 251k formed offset from the center of the spiked tank basin. The spike 251k has a spear-like structure. Referring to FIG. 11B, the spike 251 can be configured to pierce and continuously tear the foil 201 of the sealed tank 200 forming a first arc θ shaped opening in the foil 201. The first arc θ spans up to 355°.

The spike 251k may pierce the foil 201 during the first rotation or on a subsequent rotation of the sealed tank 200 depending on a height H1 of the spike. The height H1 of the spike 251k can be such that the spike 251k can tear the foil 201 up to 355°. For example, the height H1 can such that the spike 251k tears the foil 201 up to 120°. It can be appreciated by a person skilled in art that the height H1 of the spike 251k can vary depending on the amount of tearing of the foil 201 desired. For example, to tear the foil 201 for less than 120° arc the height H1 will be relatively smaller. On the other hand, to tear the foil 201 for more than 120° arc the height H1 will be relatively greater. Alternatively, a plurality of spikes of similar or different heights can be used to cause tearing of the foil 201 in different location for different amount. For example, a first spike can tear the foil 201 up to 90° and a second spike can tear the foil 201 up to 45°.

FIG. 12 illustrates assembly of the bait insert in a rat fortress RF. The rat fortress RF contains two compartments in which the bait inserts 10A and 10B (or 20) can be installed. The rat fortress RF can be transported along with the bait insert 10A and 10B (or 20).

In one embodiment of the present disclosure, the bait insert 10 (or 20) may include a plurality of sensors configured to provide metrics on the quantity of rodents/pests entering the RF. Also, the plurality of sensors may be configured to provide fluid level data of the tank. Further, the plurality of sensors may be configured to provide geo-location of the RE and thereby the bait insert 10 (or 20) being utilized. Thus, in some embodiments, a user may be able to know when to refill the bait insert 10 (or 20), which locations are most or least active and whether to reconfigure or redeploy the RF and/or bait insert to other locations, etc. via sensor data.

Further, the plurality of sensors may be configured to provide the information described above via Wi-Fi or other networking techniques to a user device or a server. The user device may include a smartphone, cellular phone, tablet computer, laptop computer or the like. This information may be configured to be accessible via a mobile application stored and implemented on the user device.

In certain embodiments, the connection between the tray top 120 and the tank 100 may include a conical surface disposed on the tray top 120 where the tank 100 is configured to press onto the conical surface to cause a friction fit. This configuration results in a more stable connection between the tray top 120 and the tank 100 and centers the tank 100 into place.

It can be understood by a person skilled in art that the flow path between the tank 100 and the plurality of the troughs can be affected by concavity of the tank basin 151, spacing beneath the tank 100 at a connection location, and the shape and size of the flow channel 152 and/or drink basin 153 to allow a free flow of liquid from the tank to the plurality of the trough.

The liquid bait used in the bait insert may vary widely. As an active agent, the bait may contain a diterpenoid epoxide comprising a triptolide skeleton and which causes ovarian follicle depletion in female mammals and may also affect the fertility of male mammals as well. Examples of such compounds are described in US 2015/0224124 at paragraphs [0013]-[0036] and [0081]-[0107], incorporated herein by reference, In a preferred embodiment, this compound is triptolide. The active agent in the liquid bait may also be an organic diepoxide which causes ovarian follicle depletion in female mammals. Such compounds are described in US 2015/0224124 at paragraphs [0109]-[40112], incorporated herein by reference. A preferred example is 4-vinylcyclohexene diepoxide (VCD). In a particularly preferred embodiment, the liquid bait contains a combination of a diterpenoid epoxide comprising a triptolide skeleton and organic diepoxide which causes ovarian follicle depletion in female mammals discussed above. Such a composition is described in US 2015/0224124, incorporated herein by reference.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the present disclosure is intended to be illustrative, but not limiting of the scope of the present disclosure, as well as other claim. The disclosure, including any readily discernible variants of the teachings herein, defines, in part, the scope of the foregoing claim terminology such that no inventive subject matter is dedicated to the public.

The above disclosure also encompasses the embodiments noted below.

(1) A bait insert including a tank filled with a liquid bait having a discharge port, a tray top having an engagement port, and a drinking area, the engagement port engaging with the discharge port of the tank and the drinking area providing external access to the liquid bait, and a tray base sealed to the tray top, wherein the tray base includes a plurality of troughs forming an internal flow paths for the liquid bait to flow from the tank to drinking area of the tray top.

(2) The bait insert of feature (1), in which plurality of troughs of the tray base includes a tank basin, which is a trough configured to collect and release the liquid bait, a drink basin, which is a trough configured to store and provides external access to the liquid bait, and a flow channel connecting the tank basin and the drink basin configured to provide a flow path for the liquid bait to and from the tank basin and to and from the drink basin.

(3) The bait insert of feature (1) to (2), in which the plurality of troughs further includes a spill recapture area surrounding the tank basin, the flow channel, and the drink basin.

(4) The bait insert of feature (1) to (3), in which the plurality of troughs are configured to allow spilling of the liquid bait from at least one of the tank basin, the flow channel, and the drink basin into the spill recapture area.

(5) The bait insert of feature (1) to (4), in which a first gap is formed between the tank basin and the spill recapture area upon assembly of the tray base and the tray top.

(6) The bait insert of feature (1) to (4), in which a second gap is formed between the drink basin and the spill recapture area upon assembly of the tray base and the tray top.

(7) The bait insert of feature (1) to (6), in which the tray base includes a groove profile along the periphery of the plurality of troughs.

(8) The bait insert of feature (1) to (7), in which the tray top includes a projection profile that fits in the groove profile to form a tight seal to prevent leakage of the liquid bait.

(9) The bait insert of feature (1) to (8), in which the drinking area of the tray top is a rectangular hole with smooth edges having an overhang projecting from the bottom surface of the tray top.

(10) The bait insert of feature (1) to (9), in which the drinking area of the tray top is a rectangular hole with smooth edges having an overhang projecting from the bottom surface of the tray top.

(11) The bait insert of feature (1) to (10), in which the drinking area of the tray top is a rectangular hole with smooth edges having an overhang projecting from the bottom surface of the tray top.

(12) The bait insert of feature (1) to (11), in which the engagement port of the tray top projects from the top surface of the tray top as well as from the bottom surface of the tray top.

(13) The bait insert of feature (1) to (12), in which wherein the tank includes a drain indicator indicating the direction of tilting of the tray base to reclaim the liquid bait from at least one of the drink basin, the flow channel, the spill recapture area, and the tank basin into the tank

(14) A spiked bait insert including a sealed tank filled with a liquid bait having a discharge port, wherein the discharge port is sealed with a foil, a tray top having an engagement port, and a drinking area, wherein the engagement port engages with the discharge port of the tank, and a spiked tray base having a spike integral to the spiked tray base, wherein the spiked tray base includes a plurality of troughs forming an internal flow paths for the liquid bait to and from the tank to drinking area of the tray top the spike is configured to pierce the foil of the sealed tank to allow the liquid bait to flow from the sealed tank to the spiked tray.

(15) The spiked bait insert of feature (14), in which the plurality of troughs of the tray base includes a spiked tank basin, which is a trough with the spike formed integral to the spiked tank basin, a drink basin, which is a trough configured to store and provides external access to the liquid bait, and a flow channel connecting the tank basin and the drink basin configured to provide a flow path for the liquid bait to and from the tank basin and to and from the drink basin.

(16) The spiked bait insert of feature (14) to (15), in which the plurality of troughs further comprises a spill recapture area surrounding the tank basin, the flow channel, and the drink basin.

(17) The spiked bait insert of feature (14) to (16), in which the spike is formed offset from the center of the spiked tank basin.

(18) The spiked bait insert of feature (14) to (17), in which the spike is configured to pierce and continuously tear the foil of the sealed tank forming a first arc shaped opening in the foil.

(19) The spiked bait insert of feature (14) to (18), in which the spike is configured to pierce and continuously tear the foil of the sealed tank forming a first arc shaped opening in the foil.

(20) The spiked bait insert of feature (14) to (19), in which the first arc spans up to 355°.

What is claimed is:

1. A bait insert comprising:
a tank filled with a liquid bait having a discharge port;
a tray top having an engagement port and a drinking area, wherein the engagement port engages with the discharge port of the tank and the drinking area provides external access to the liquid bait; and
a tray base sealed to the tray top, wherein the tray base comprises a plurality of troughs forming an internal flow path for the liquid bait to flow to and from the tank to the drinking area of the tray top.

2. The bait insert according to claim 1, wherein the plurality of troughs of the tray base comprises:
a tank basin, which is a trough configured to collect and release the liquid bait;
a drink basin, which is a trough configured to store and provides external access to the liquid bait; and
a flow channel connecting the tank basin and the drink basin configured to provide a flow path for the liquid bait to and. from the tank basin, and to and from the drink basin.

3. The bait insert according to claim 2, wherein the plurality of troughs further comprises a spill recapture area surrounding the tank basin, the flow channel and the drink basin.

4. The bait insert according to claim 3, wherein the plurality of troughs are configured to allow spilling of the liquid bait from at least one of the tank basin, the flow channel, and the drink basin into the spill recapture area.

5. The bait insert according to claim 4, wherein a first gap is formed between the tank basin and the spill recapture area upon assembly of the tray base and the tray top.

6. The bait insert according to claim 4, wherein a second gap is formed between the drink basin and the spill recapture area upon assembly of the tray base and the tray top.

7. The bait insert according to claim 2, wherein the tray base includes a groove profile formed along the periphery of the plurality of troughs.

8. The bait insert according to claim 7, wherein the tray top includes a projection profile formed to fit in the groove profile to form a tight seal to prevent leakage of the liquid bait.

9. The bait insert according to claim 2, wherein the drinking area of the tray top is a rectangular hole with smooth edges having an overhang projecting from the underside of the tray top.

10. The bait insert according to claim 9, wherein the overhang of the drinking area conforms to the drink basin of the tray base so that contact is made with the inner walls of the drink basin when assembled.

10. The bait insert according to claim 1, wherein the tray top includes a corral projecting from the top surface of the tray top and surrounding the drinking area.

12. The bait insert according to claim 1, wherein the engagement port of the tray top projects from the top surface of the tray top and from the underside of the tray top.

13. The bait insert according to claim 1, wherein the tank includes a drain indicator indicating the direction of tilting of the tray base to reclaim the liquid bait from at least one of the drink basin, the flow channel, the spill recapture area, and the tank basin into the tank.

14. A spiked bait insert comprising:
a sealed tank filled with a liquid bait having a discharge port sealed with a foil;
a tray top having an engagement port and a drinking area, the engagement port engages with the discharge port of the tank and the drinking area provides external access to the liquid bait; and
a spiked tray base having a spike integral to the spiked tray base, wherein the spiked tray base includes a plurality of troughs forming an internal flow path for the liquid bait to from to and from the tank to drinking area of the tray top, and the spike is configured to pierce the foil of the sealed tank to allow the liquid bait to flow from the sealed tank to the spiked tray.

15. The spiked bait insert according to claim 1, wherein the plurality of troughs of the spiked tray base comprises:
a spiked tank basin, which is a trough with the spike formed integral to the spiked tank basin;
a drink basin, which is a trough configured to store and provides external access to the liquid bait; and
a flow channel connecting the tank basin and the drink basin configured to provide a flow path for the liquid bait to and from the tank basin and to and from the drink basin.

16. The spiked bait insert according to claim 15, wherein the plurality of troughs further comprises a spill recapture area surrounding the spiked tank basin, the flow channel, and the drink basin.

17. The spiked bait insert according to claim 16, wherein the spike is formed offset from the center of the spiked tank basin.

18. The spiked bait insert according to claim 17, wherein the spike is configured to pierce and continuously tear the foil of the sealed tank forming a first arc shaped opening in the foil.

19. The spiked bait insert according to claim 18, wherein the first arc spans up to 355°.

20. A feeder tray comprising:
a tray top having an engagement port and a drinking area, wherein the engagement port engages provides connection with an external component and the drinking area serves as an external access to a liquid; and
a tray base sealed to the tray top forming an internal flow path for the liquid to flow to and from the tank to the drinking area of the tray top, wherein the internal flow paths are formed by a plurality of troughs comprising a tank basin, which is a trough configured to collect and release the liquid; a drink basin, which is a trough configured to store and provides external access to the liquid; a flow channel connecting the tank basin and the drink basin configured to provide a flow path for the liquid to and from the tank basin, and to and from the drink basin; and a spill recapture area surrounding the tank basin, the flow channel and the drink basin configured to reclaim spilling of the liquid from at least one of the tank basin, the flow channel and the drink basin.
